(19) United States
(12) Patent Application Publication
(10) Pub. No.: US 2020/0160861 A1
(43) Pub. Date: May 21, 2020

(54) APPARATUS AND METHOD FOR PROCESSING VOICE COMMANDS OF MULTIPLE TALKERS

(71) Applicants: HYUNDAI MOTOR COMPANY, SEOUL (KR); KIA MOTORS CORPORATION, SEOUL (KR)

(72) Inventor: Seung Shin LEE, Seoul (KR)

(73) Assignees: HYUNDAI MOTOR COMPANY, SEOUL (KR); KIA MOTORS CORPORATION, SEOUL (KR)

(21) Appl. No.: 16/378,115

(22) Filed: Apr. 8, 2019

(30) Foreign Application Priority Data
Nov. 16, 2018 (KR) 10-2018-0142018

(51) Int. Cl. G10L 15/22; B60R 16/037

(52) U.S. Cl. CPC G10L 15/22; B60W 50/10; G10L 2015/223; B60R 16/0373

(57) ABSTRACT

A voice command processing system and a method are provided. The system includes a vehicle terminal configured to receive a voice signal via a microphone and separating and outputting a speech signal of each talker from the voice signal and a server configured to recognize a command for each talker by performing a speech recognition of the speech signal of each talker and analyzing an intention of the command for each talker to provide the vehicle terminal with an analysis result. The vehicle terminal performs an operation corresponding to the command for each talker based on the analysis result.

### CROSS-REFERENCE TO RELATED APPLICATION

The present application claims priority to and the benefit of Korean Patent Application No. 10-2018-0142018, filed on Nov. 16, 2018, which is incorporated herein by reference in its entirety.

### TECHNICAL FIELD

The present disclosure relates to a voice command processing system and a method that recognize and process multiple voice commands uttered by multiple talkers.

### BACKGROUND

The statements in this section merely provide background information related to the present disclosure and may not constitute prior art.

The importance of speech recognition technology is increasing in the automotive field. Because a speech recognition technology is capable of controlling a vehicle with voice without any physical manipulation of a driver, it is possible to solve the risk factors that may be caused by the manipulation of a navigation device or a convenience function while the vehicle is driving.

As such, an intelligent virtual assistant service using the speech recognition technology is being continuously applied to vehicles. The intelligent virtual assistant accurately grasps the driver's intention and provides a feedback.

However, a conventional speech recognition technology may support receiving and processing one voice command from a single talker. Accordingly, conventionally, the received command may not be processed normally, when a plurality of talkers simultaneously direct different commands or when a single talker enters a plurality of commands.

### SUMMARY

An aspect of the present disclosure provides a voice command processing system and method that recognize and process multiple voice commands uttered by multiple talkers.

The technical problems to be solved by the present inventive concept are not limited to the aforementioned problems, and any other technical problems not mentioned herein will be clearly understood from the following description by those skilled in the art to which the present disclosure pertains.

In one form the present disclosure, a voice command processing system includes a vehicle terminal receiving voice signals via a microphone and separating and outputting a speech signal of each talker from the voice signals and a server performing speech recognition on the speech signal of each talker to recognize a command for each talker and analyzing intention of the command for each talker to provide the vehicle terminal with an analysis result of the intention. The vehicle terminal performs an operation corresponding to the command for each talker based on the analysis result.

In one form of the present disclosure, the vehicle terminal analyzes the voice signals, estimates a talker count, and determines whether multiple talkers are present.

In one form of the present disclosure, when the estimated talker count is not less than two, the vehicle terminal determines that the multiple talkers are present to separate the speech signal of each talker from the voice signals.

In one form of the present disclosure, the vehicle terminal transmits status information, which is stored in a memory and which is capable of being supported in a vehicle, to the server upon starting the speech recognition.

In one form of the present disclosure, the status information capable of being supported in the vehicle includes an executable command for each function, a command capable of being processed simultaneously, and an execution priority for each command.

In one form of the present disclosure, the server analyzes intention of the command for each talker, using the status information capable of being supported in the vehicle.

In one form of the present disclosure, the vehicle terminal determines validity for the command for each talker based on the analysis result and selects a valid command.

In one form of the present disclosure, the vehicle terminal classifies the selected valid command for each domain and determines an execution order depending on a priority in a classified domain.

In one form of the present disclosure, the vehicle terminal executes the selected valid command depending on a domain priority.

In one form of the present disclosure, a vehicle terminal includes a communication device communicating with a server, a microphone installed in a vehicle and receiving voice signals, and a processor. The processor separates the voice signals into a speech signal of each talker to transmit the speech signal of each talker to the server, receives an intention analysis result from performing speech recognition and intention analysis on the speech signal of each talker from the server, and processes a command for each talker based on the intention analysis result.

In one form of the present disclosure, a method for processing a voice command includes receiving, by a vehicle terminal, voice signals via a microphone, separating, by the vehicle terminal, the voice signals into a speech signal of each talker, transmitting, by the vehicle terminal, the speech signal of each talker to a server, performing, by the server, speech recognition on the speech signal of each talker to recognize a command for each talker, analyzing, by the server, intention of the command for each talker to transmit an analysis result of the intention to the vehicle terminal, and performing, by the vehicle terminal, an operation corresponding to the command for each talker based on the analysis result.

In one form of the present disclosure, the vehicle terminal detects one voice signal in which voice commands uttered by multiple talkers via a single microphone installed in a vehicle are mixed, in the receiving of the voice signals.

In one form of the present disclosure, the separating of the voice signal includes analyzing, by the vehicle terminal, the voice signals to estimate a talker count, determining, by the vehicle terminal, whether multiple talkers are present, based on the estimated talker count, and separating, by the vehicle terminal, the speech signal of each talker from the voice signals based on the estimated talker count when the multiple talkers are present.

In one form of the present disclosure, The vehicle terminal performs a speech recognition function, when manipulation of a button to which a speech recognition execution command is assigned in a vehicle is detected or when an utterance of a preset wakeup keyword is detected, before the receiving of the voice signals.

In one form of the present disclosure, the vehicle terminal transmits status information, which is stored in a memory and which is capable of being supported in the vehicle, to the server upon performing the speech recognition.

In one form of the present disclosure, the status information capable of being supported in the vehicle includes an executable command for each function, a command capable of being processed simultaneously, and an execution priority for each command.

In one form of the present disclosure, the server analyzes intention of the command for each talker, using the status information capable of being supported in the vehicle.

In one form of the present disclosure, the vehicle terminal determines validity for the command for each talker based on the analysis result and selects a valid command, in the performing the operation corresponding to the command for each talker.

In one form of the present disclosure, the vehicle terminal classifies the selected valid command for each domain and determines an execution order depending on a priority in a classified domain, in the performing the operation corresponding to the command for each talker.

In one form of the present disclosure, the vehicle terminal executes the valid command selected depending on a domain priority, in the performing the operation corresponding to the command for each talker.

Further areas of applicability will become apparent form the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a voice command processing system in one form of the present disclosure;

FIG. 2 is a view for describing a process of separating sound sources in one form of the present disclosure;

FIG. 3 is a view illustrating a domain priority in one form of the present disclosure;

FIG. 4 is a view for describing a speech recognition process in one form of the present disclosure;

FIG. 5 is a flowchart illustrating a voice command processing method in one form of the present disclosure; and

FIG. 6 is a flowchart illustrating a procedure of processing a command illustrated in FIG. 5.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some forms of the present disclosure will be described in detail with reference to the accompanying drawings.

In the drawings, the same reference numerals will be used throughout to designate the same or equivalent elements. In addition, a detailed description of well-known features or functions will be ruled out in order not to unnecessarily obscure the gist of the present disclosure.

In describing elements of some forms of the present disclosure, the terms first, second, A, B, (a), (b), and the like may be used herein. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which this disclosure belongs. It will be understood that terms used herein should be interpreted as having a meaning that is consistent with their meaning in the context of the present disclosure and the relevant art and will not be interpreted in an idealized or overly formal sense unless expressly so defined herein.

The present disclosure relates to a complex voice command support technology for recognizing a plurality of voice commands simultaneously or sequentially uttered by a plurality of talkers in a vehicle and analyzing and processing command intention for each talker.

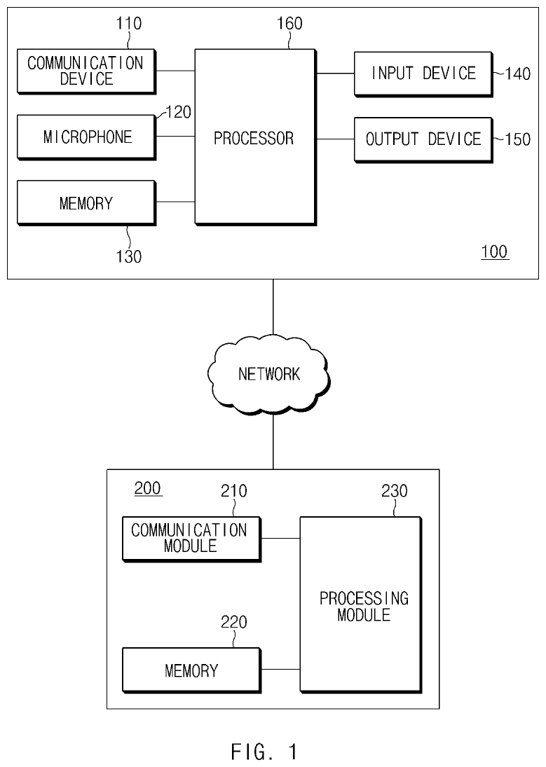

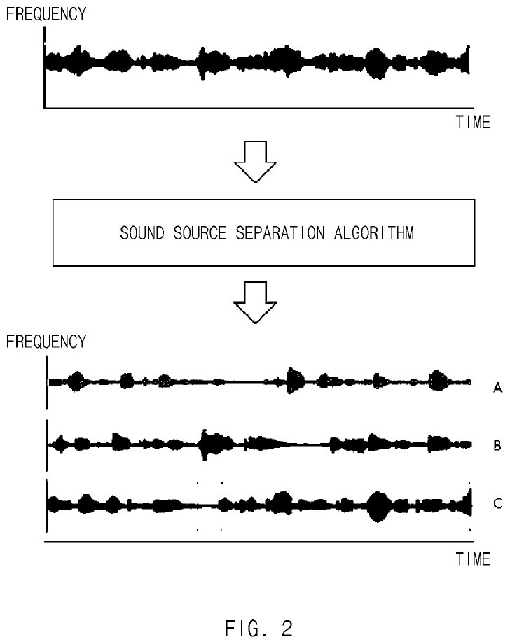

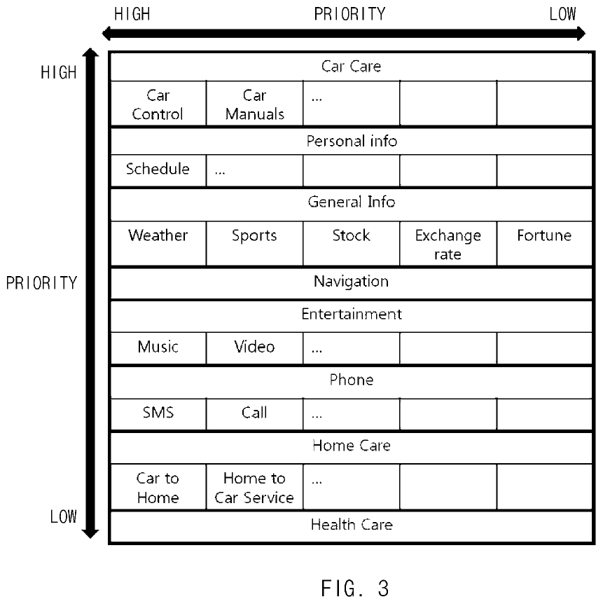

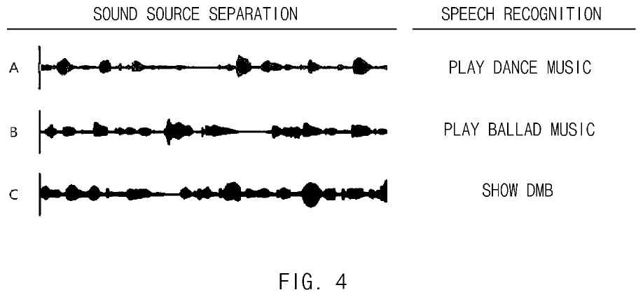

FIG. 1 is a block diagram illustrating a voice command processing system in some forms of the present disclosure. FIG. 2 is a view for describing a process of separating sound sources associated with the disclosure. FIG. 3 is a view illustrating a domain priority associated with the disclosure. FIG. 4 is a view for describing a speech recognition process associated with the disclosure.

Referring to FIG. 1, a voice command processing system includes a vehicle terminal 100 and a server 200, which are connected over a network. Herein, the network may be implemented with a wireless Internet network such as Wireless LAN (WLAN) (Wi-Fi), Wireless broadband (Wibro) and/or World Interoperability for Microwave Access (Wimax) and/or a mobile communication network such as Code Division Multiple Access (CDMA), Global System for Mobile (GSM) communication, Long Term Evolution (LTE) and/or LTE-Advanced (LTE-A).

The vehicle terminal 100 may be implemented with a telematics terminal, an Audio Video Navigation (AVN), or the like as a device mounted on a vehicle. The vehicle terminal 100 includes a communication device 110, a microphone 120, a memory 130, an input device 140, an output device 150, and a processor 160.

The communication device 110 enables wireless communication between the vehicle terminal 100 and the server 200. The communication device 110 transmits data (information) according to the direction of the processor 160 or receives data transmitted from the server 200.

The microphone 120 is a sound sensor that converts an external acoustic signal (e.g., a sound wave) into an electrical signal. The microphone 120 may be implemented with various noise removal algorithms for removing noise input together with the acoustic signal. In other words, the microphone 120 may remove a noise, which is generated while a vehicle is driving or which is input from the outside, from the acoustic signal input from the outside to output the noise-free acoustic signal.

The microphone 120 detects (obtains) a voice signal output from a user (talker) in the vehicle. The microphone 120 may also obtain (sense) a voice signal output from two or more talkers. In other words, the microphone 120 obtains the voice signals simultaneously uttered by a plurality of talkers, as one mixed voice signal at a time.

The memory 130 may store a program for the operation of the processor 160 and may store data that is input and/or output. The memory 130 may be implemented with at least one or more storage media (recording media) among a flash memory, a hard disk, a Secure Digital (SD) card, a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), a register, a removable disc, web storage, and the like.

The memory 130 may store a voice feature information database (DB) for each pre-registered talker, a command validity criterion, a feature list including status information capable of being supported in the vehicle, a domain priority, and the like. The status information capable of being supported in the vehicle includes an executable command for each function (domain), a command capable of being processed simultaneously, an execution priority for each command, and the like.

Moreover, the memory 130 may store a talker count estimation algorithm, a sound source separation algorithm, a talker identification algorithm, a speech recognition algorithm, an intention analysis algorithm, a multiple command processing determination algorithm, a multiple command processing algorithm, and the like. The memory 130 may store an application (hereinafter referred to as an “app”) that performs a specific function (e.g., vehicle control, navigation, multimedia playback, call, air conditioning control, provision of weather information, or the like).

The input device 140 may generate data according to a user's manipulation. For example, the input device 140 generates data for executing a speech recognition function in response to a user input. The input device 140 may be implemented with a keyboard, a keypad, a button, a switch, a touch pad, and/or a touch screen.

The output device 150 outputs the progress status and result according to the operation of the processor 160 in the form of visual information, auditory information and/or tactile information. The output device 150 may include a display, a sound output module, a tactile information output module, and the like.

The display may be implemented with one or more of a liquid crystal display (LCD), a thin film transistor-liquid crystal display (TFT LCD), an organic light-emitting diode (OLED) display, a flexible display, a 3D display, a transparent display, head-up display (HUD), a touch screen, and a cluster.

The sound output module may output the audio data stored in the memory 130. The sound output module may include a receiver, a speaker, and/or a buzzer.

The tactile information output module outputs a signal of a type that the user can perceive with a tactile sense. For example, the tactile information output module may be implemented with a vibrator to control vibration intensity, a vibration pattern, and the like.

The processor 160 controls the overall operation of the vehicle terminal 100. The processor 160 may be implemented with at least one or more of an Application Specific Integrated Circuit (ASIC), a Digital Signal Processor (DSP), a Programmable Logic Devices (PLD), Field Programmable Gate Arrays (FPGAs), a Central Processing Unit (CPU), micro-controllers, and microprocessors.

The processor 160 executes (operate) a speech recognition function when receiving a speech recognition execution command input through the microphone 120 or the input device 140. For example, the input device 140 detects the user's manipulation to generate a speech recognition execution command, and the processor 160 operates the speech recognition function depending on the speech recognition execution command, when a user manipulates a speech recognition button located on the steering wheel. Alternatively, the processor 160 recognizes a wakeup keyword through the microphone 120 and executes a speech recognition function, when a user utters a preset wakeup keyword (a wakeup word).

When there is no voice command input through the microphone 120 within a predetermined time after the speech recognition function is executed, the processor 160 switches the operating mode of the speech recognition function to a sleep mode. The processor 160 maintains the sleep mode until the processor 160 receives the speech recognition execution command from the microphone 120 or the input device 140, when the operating mode of the speech recognition function is switched to the sleep mode.

The processor 160 transmits (transfer) the feature list stored in the memory 130 to the server 200 via the communication device 110, at the beginning of speech recognition, that is, when the speech recognition function is executed. Herein, the feature list includes the names of domains capable of processing multiple commands (multiple instructions) in a vehicle and is used as a hint upon analyzing a talker's intent.

The processor 160 obtains (detects) a voice signal through the microphone 120 after executing the speech recognition function. The processor 160 obtains a voice signal (including a voice command) that at least one or more talkers utter at a time, through one microphone 120 mounted on the vehicle.

The processor 160 estimates (predicts) a concurrent talker count by analyzing the voice signal input through the microphone 120. The processor 160 may estimate the talker count using the well-known talker count estimation algorithm. A deep Learning algorithm such as Deep Neural Network (DNN) and/or Recurrent Neural Network (RNN) may be used as a talker count estimation algorithm.

The processor 160 converts the data format of the voice signal (voice data) obtained depending on the communication protocol when the talker count is one. The processor 160 transmits the converted voice signal to the server 200 via the communication device 110.

When the talker count is not less than two, the processor 160 may separate a voice signal (sound source) for each talker from the voice signal, using a sound source separation algorithm. In other words, the processor 160 separates the voice signal (voice data) for each talker from the input voice signal, when the voice signal input through the microphone 120 is a voice signal uttered by multiple talkers. Herein, the sound source separation algorithm separates a talker depending on the type of sound waves and the unique voice frequency band, which are unique for each talker. The processor 160 provides the separated voice signal for each talker to the server 200.

For example, referring to FIG. 2, the processor 160 executes a sound source separation algorithm using the received voice signal as input data to classify voice signals A, B, and C for each talker, when receiving a voice signal (a complex voice signal) uttered by multiple talkers from the microphone 120.

The processor 160 may extract the feature information from the separated voice signal for each talker and may identify the talker by comparing the extracted feature information with the feature information DB for each talker stored in the memory 130. The processor 160 may distinguish and recognize a main talker (driver) and a sub talker (passenger) when identifying the talker.

The processor 160 receives the intention analysis result transmitted from the server 200 via the communication device 110. The processor 160 determines whether multiple commands are present, based on the intention analysis result provided by the server 200. That is, the processor 160 may determine whether the intention analysis result includes two or more commands (instructions).

The processor 160 determines the validity for each command included in the intention analysis result, when the determination result indicates multiple commands. In other words, the processor 160 may select a valid command among multiple commands in the intention analysis result by determining whether each command can be processed. Moreover, the processor 160 may select a command capable of being processed simultaneously, among the selected valid commands.

The processor 160 generates an array list of commands to be executed for each app based on the selected valid command to transmit the array list to the app. In other words, the processor 160 generates an array list by sorting commands to be executed for each domain depending on an execution order. The processor 160 transmits an array list for each domain to each domain.

The processor 160 determines the execution order (operation order) depending on the uttered order in the case of valid commands belonging to the same domain. Furthermore, the processor 160 registers only one command in the array list, when the intention analysis result for two or more voice commands indicates that there is only single intent. The processor 160 registers only maximum four valid commands in the array list depending on a priority, in consideration of the accuracy and operation time of intention analysis when there are five valid commands or more.

The processor 160 controls the app depending on the domain priority to execute the transmitted command. The processor 160 executes multiple commands simultaneously or sequentially depending on the domain priority. For example, the processor 160 simultaneously executes the command of talker A and the command of talker B when the domain priority of each of the command of talker A and the command of talker B are the same as each other and it is possible to simultaneously process the command of talker A and the command of talker B. In the meantime, the processor 160 sequentially processes the command of talker A and the command of talker B depending on the utterance order or the intention analysis result, when domain priorities of the command of talker A and the command of talker B are different from each other or when the domain priorities are the same as each other but it is impossible to process the command of talker A and the command of talker B simultaneously.

Herein, the domain priority refers to the operation execution priority for each vehicle domain. The domain priority is given according to the importance of the function in the vehicle, the operation time in the scenario, and whether the dialog mode or function is linked. The priority for each detailed domain is determined based on frequency of use, usefulness of information capable of being provided, and the like.

For example, a function to display the result or information on the screen by using a graphic user interface (GUI) in a single view, a function to give only the one-time answer as a system response, or the like has high priority, because the time to perform the operation is short in the scenario,

Referring to FIG. 3, a top priority is assigned to a function (domain) with a high function importance in the vehicle, such as ‘Car Care’, and a low priority is assigned to a function with a low function importance in the vehicle, such as ‘Home Care’ and ‘Health Care’. Also, the priority is assigned to the detailed domain in the domain.

The server 200 performs speech recognition on the voice signal (voice data) transmitted from the vehicle terminal 100 and analyzes intention to provide the intention analysis result to the vehicle terminal 100. The server 200 may include a communication module 210, a memory 220, and a processing module 230.

The communication module 210 receives data transmitted from the vehicle terminal 100 and transmits data to the vehicle terminal 100 under control of the processing module 230. The communication module 210 may support wired Internet access such as Local Area Network (LAN), Wide Area Network (WAN), Ethernet, and/or Integrated Services Digital Network (ISDN).

The memory 220 stores software programmed for the processing module 230 to perform the predetermined operation. The memory 220 may store input data and/or output data of the processing module 230.

In addition, the memory 220 may include a natural language processing algorithm, a speech recognition algorithm, an intention analysis algorithm, and the like. The memory 220 may store the voice model DB.

The memory 220 may be implemented with at least one or more storage media (recording media) among a storage medium such as a flash memory, a hard disk, a RAM, an SRAM, a ROM, a PROM, an EEPROM, an EPROM, a register, a web storage, and the like.

The processing module 230 controls the overall operation of the server 200. The processing module 230 may be implemented with at least one of an ASIC, a DSP, a PLD, FPGAs, a CPU, a micro controller, and a micro-processor.

The processing module 230 receives a voice signal (voice data) transmitted from the vehicle terminal 100 via the communication module 210. The received voice signal may be the voice signal uttered from a single talker or the separated (classified) voice signals for each talker.

The processing module 230 converts the received voice signal into a text through a speech recognition algorithm. The processing module 230 performs speech recognition on each of the separated voice signals for each talker.

For example, as illustrated in FIG. 4, the processing module 230 performs speech recognition on each voice signal to convert the voice signal of talker A, the voice signal of talker B, and the voice signal of talker C into “play dance music”, “play ballad music” and “show DMB”, respectively, when the processing module 230 receives the voice signal of talker A, the voice signal of talker B, and the voice signal of talker C.

The processing module 230 analyzes the intention of the command for each talker, which is converted to the text through speech recognition. The processing module 230 may analyze the intention of a talker for the command for each talker, using the well-known intention analysis algorithm. For example, the processing module 230 determines the intention of the talker as ‘play music’ through intention analysis when the command recognized through speech recognition is ‘play dance music’.

The processing module 230 transmits the intention analysis result to the vehicle terminal 100 when the intention analysis for each recognized command is completed through speech recognition. At this time, the processing module 230 determines an execution priority of the commands from grasping the intention of the talker and whether each of the commands from grasping the intention of the talker is capable of being performed and reflects the determined result to the intention analysis result. In other words, the processing module 230 extracts only valid commands, which are executable in the vehicle, from among commands, the intention analysis of each of which is completed, and sorts the extracted commands depending on the execution priority to output the sorted commands as the intention analysis result. Here, the intention analysis result is generated in a data exchange format such as JavaScript Object Notation (JSON).

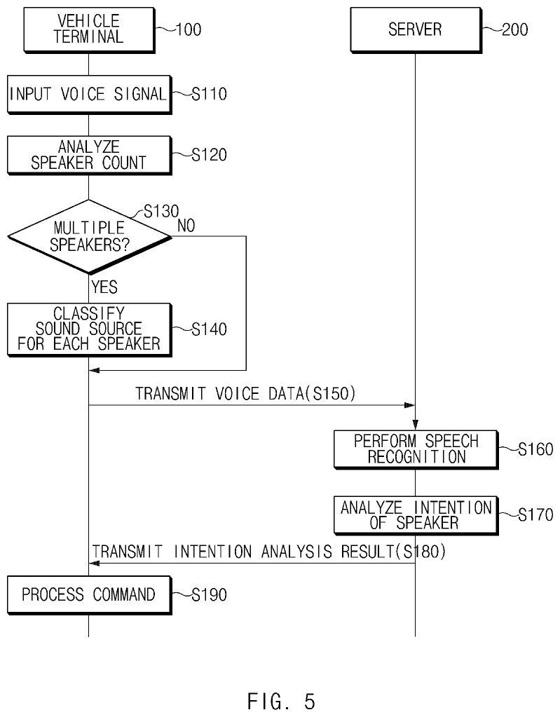

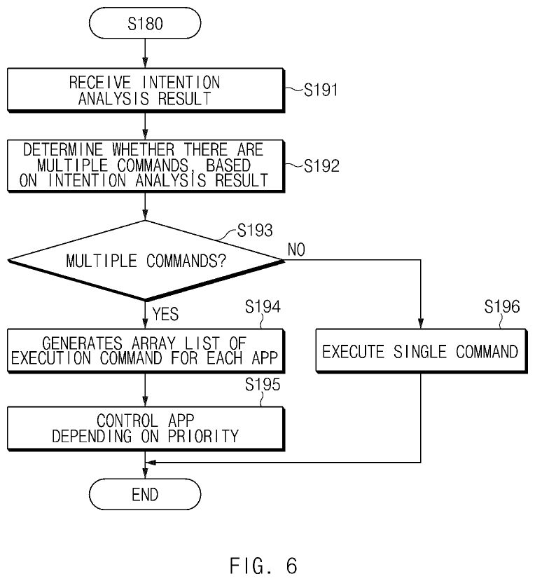

FIG. 5 is a flowchart illustrating a voice command processing method in some forms of the present disclosure. FIG. 6 is a flowchart illustrating a procedure of processing a command illustrated in FIG. 5.

Referring to FIG. 5, in operation S110, the vehicle terminal 100 receives a voice signal via the microphone 120. The vehicle terminal 100 may perform a speech recognition function and then may obtain a voice signal, which is uttered by two or more talkers, at one time via the single microphone 120, when a speech recognition execution command is entered. For example, the vehicle terminal 100 executes the speech recognition function, when the manipulation of a speech recognition button installed in a vehicle is detected or an utterance of a preset wakeup keyword is detected. The vehicle terminal 100 obtains three voice commands through the microphone 120 as one voice signal, when three talkers simultaneously utter the three voice commands being ‘play music for Michael Jackson’, ‘search for S coffee’, and ‘show DMB’ after executing the speech recognition function.

In operation S120, the vehicle terminal 100 analyzes the talker count based on the input voice signal. Because the vehicle terminal 100 analyzes the input voice signal using the talker count estimation algorithm, the vehicle terminal 100 estimates the number of talkers that utter commands simultaneously.

In operation S130, the vehicle terminal 100 determines whether there are multiple talkers, based on the talker count analysis result. In operation S130, the vehicle terminal 100 determines whether the estimated talker count is not less than two.

In operation S140, the vehicle terminal 100 classifies (separates) a sound source for each talker from the input voice signal, when there are multiple talkers. For example, the vehicle terminal 100 separates the voice signals of the talker A, talker B, and talker C from the input voice signal, when the talker count is three.

In operation S150, the vehicle terminal 100 transmits the separated voice signals (voice data) for each talker to the server 200.

In the meantime, the vehicle terminal 100 transmits the voice signal input through the microphone, to the server 200, when the talker count analysis result indicates a single in operation S130.

In operation S160, the server 200 receives a voice signal transmitted from the vehicle terminal 100 to perform speech recognition. The server 200 performs speech recognition on the corresponding voice signal to convert the voice signal into a text, when the received voice signal is a voice signal of a single talker. In addition, the server 200 performs speech recognition on the voice signal for each talker to convert the voice signal to a text, when the received voice signal is a separated voice signal for each talker.

In operation S170, the server 200 performs command intention analysis of a talker on the command (instruction) converted to the text through speech recognition. For example, the server 200 determines pieces of command intention of the talker as ‘music playback’, ‘map search’ and ‘unknown’, respectively, when the commands recognized through speech recognition are ‘play music for Michael Jackson’, ‘search for S coffee’, and ‘show DMB’.

At this time, the server 200 may firstly classify the domains of speech recognition commands and perform command intention analysis for each classified domain. For example, when the commands recognized through speech recognition are ‘play music A’, ‘play music A’, and ‘search for S coffee’, the server 200 classifies the domains of the commands as ‘entertainment’, ‘entertainment’, and ‘navigation’, respectively. Afterward, the server 200 analyzes the pieces of intention of ‘play music A’ and ‘play music A’ that are the commands classified as ‘entertainment’; the server 200 processes only a single command as ‘play music A’, when the pieces of intention of the two commands are the same as each other.

In operation S180, the server 200 transmits the intention analysis result to the vehicle terminal 100 when the command intention analysis is completed. The server 200 generates the intention analysis result in the form of data such as JSON.

In operation S190, the vehicle terminal 100 processes the command based on the intention analysis result provided from the server 200.

Hereinafter, the command processing method will be described in more detail with reference to FIG. 6.

In operation S191, the vehicle terminal 100 receives the intention analysis result transmitted from the server 200.

In operation S192, the vehicle terminal 100 determines whether there are multiple commands, based on the intention analysis result. The vehicle terminal 100 identifies the number of commands (command count) in the intention analysis result and then determines whether there are multiple commands, depending on the identification result. That is, the vehicle terminal 100 determines that there are multiple commands, when the intention analysis result indicates that the number of commands is not less than two.

For example, the vehicle terminal 100 determines ‘talker A: play music’, ‘talker B: search a map’ and ‘talker C: ignore a command’ depending on whether each command is executable, when the result intention analysis result indicates that pieces of command intention of talker A, talker B, and talker C correspond to ‘play music’, ‘search a map’ and ‘unknown’. Accordingly, the vehicle terminal 100 determines that two execution commands are present.

In operation S193, the vehicle terminal 100 determines whether multiple commands are present, based on the determination result.

In operation S194, the vehicle terminal 100 generates an array list of execution command for each app (domain), when the multiple commands are present. The vehicle terminal 100 determines an execution order based on an utterance order, generates the array list, and transmits the array list to the app, when the number of commands for each domain is plural.

In operation S195, the vehicle terminal 100 sequentially executes multiple commands depending on the domain priority. For example, since the navigation domain has a higher priority than the entertainment domain, the vehicle terminal 100 may first perform the map search through a navigation app and may play music through an entertainment app. Also, the vehicle terminal 100 may provide a guide indicating that it is impossible to execute the command of talker C. At this time, the vehicle terminal 100 may output the reason that it is impossible to execute a command (e.g., it is impossible to understand a command).

In the meantime, in operation 196, the vehicle terminal 100 executes the command based on the intention analysis result, when the determination result in operation S193 does not indicate multiple commands. That is, the vehicle terminal 100 operates a function corresponding to a single command recognized through speech recognition and intention analysis.

In some forms of the present disclosure, the vehicle terminal 100 performs talker count analysis, sound source separation for each talker, validation of a talker command and whether talker commands are capable of being processed simultaneously, and multiple command processing, and the server 200 performs speech recognition and intention analysis. However, some form of the present disclosure are not limited thereto. The server 200 may be implemented to perform talker count analysis, sound source separation for each talker, speech recognition and intention analysis, and validation of a talker command and whether talker commands are capable of being processed simultaneously. For example, the vehicle terminal 100 receives a voice signal through the microphone 120 to transmit the voice signal to the server 200, and the server 200 analyzes the voice signal to estimate a talker count, classifies voice data for each talker depending on the estimated talker count, performs speech recognition and intention analysis, and provides an execution command and an execution order to the vehicle terminal 100 to allow the vehicle terminal 100 to process multiple commands.

In some forms of the present disclosure, multiple voice commands simultaneously or sequentially uttered by a plurality of talkers in a vehicle may be recognized and processed at a time, thereby improving the effectiveness of the voice secretary service and the convenience of a user.

Moreover, in some forms of the present disclosure, because multiple voice commands uttered by multiple talkers are recognized and processed, the customized service for each user (driver and passenger) on board in a vehicle is possible.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A voice command processing system, the system comprising:
a vehicle terminal configured to:
receive a voice signal via a microphone; and
separate and output a speech signal of each talker from the voice signal; and
a server configured to:
recognize a command for each talker by performing speech recognition of the speech signal of each talker;
analyze an intention of the command for each talker; and
transfer, to the vehicle terminal, an analysis result,
wherein the vehicle terminal is configured to perform an operation corresponding to the command for each talker based on the analysis result.

2. The system of claim 1, wherein the vehicle terminal is configured to:
analyze the voice signal;
estimate the number of talkers; and
determine whether multiple talkers are present.

3. The system of claim 2, wherein the vehicle terminal is configured to:
when the estimated number of talkers is greater than or equal to two, determine that the multiple talkers are present; and
separate the speech signal of each talker from the voice signal.

4. The system of claim 1, wherein the vehicle terminal is configured to:
transmit, to the server, status information stored in a memory when the speech recognition is performed.

5. The system of claim 4, wherein the status information comprises an executable command for each function, a command capable of being processed simultaneously, and an execution priority for each command.

6. The system of claim 4, wherein the server is configured to:
analyze the intention of the command for each talker using the status information.

7. The system of claim 1, wherein the vehicle terminal is configured to:
determine a validity for the command for each talker based on the analysis result; and
select a valid command.

8. The system of claim 7, wherein the vehicle terminal is configured to:
classify the selected valid command into a domain; and
determine an execution order depending on a priority in the classified domain.

9. The system of claim 8, wherein the vehicle terminal is configured to:
execute the selected valid command depending on the priority in the classified domain.

10. The system of claim 1, wherein the server is configured to:
receive, from the vehicle terminal, the voice signal; and
separate the voice signal into the speech signal of each talker.

11. A vehicle terminal comprising:
a communication device configured to communicate with a server;
a microphone installed in a vehicle and configured to receive a voice signal; and
a processor configured to:
separate the voice signal into a voice signal of each talker;
transmit, to the server, the voice signal of each talker;
receive, from the server, an analysis result that analyzes an intention of the speech signal of each talker; and
process a command for each talker based on the analysis result.

12. A method for processing a voice command, the method comprising:
receiving, by a vehicle terminal, a voice signal via a microphone;
separating, by the vehicle terminal, the voice signal into a speech signal of each talker;
transmitting, by the vehicle terminal, the speech signal of each talker to a server;
recognizing, by the server, a command for each talker by performing a speech recognition of the speech signal of each talker;
analyzing, by the server, an intention of the command for each talker;
transmitting, by the server, an analysis result to the vehicle terminal; and
performing, by the vehicle terminal, an operation corresponding to the command for each talker based on the analysis result.

13. The method of claim 12, wherein receiving the voice signal comprises:
detecting, by the vehicle terminal, one voice signal that combines voice commands uttered by multiple talkers via a single microphone installed in a vehicle.

14. The method of claim 12, wherein separating the voice signal into the speech signal of each talker comprises:
analyzing, by the vehicle terminal, the voice signal to estimate the number of talkers;
determining, by the vehicle terminal, whether multiple talkers are present based on the estimated number of talkers; and
separating, by the vehicle terminal, the speech signal of each talker from the voice signal based on the estimated number of talkers when the multiple talkers are present.

15. The method of claim 12, wherein the method further comprises:
performing, by the vehicle terminal, a speech recognition when manipulation of a button to which a speech recognition execution command is assigned in a vehicle is detected or when an utterance of a preset wakeup keyword is detected.

16. The method of claim 15, wherein the method further comprises:
transmitting, by the vehicle terminal, status information stored in a memory to the server when the speech recognition is performed.

17. The method of claim 16, wherein the status information comprises an executable command for each function, a command capable of being processed simultaneously, and an execution priority for each command.

18. The method of claim 16, wherein the method further comprises:
analyzing, by the server, the intention of the command for each talker using the status information.

19. The method of claim 12, wherein performing the operation corresponding to the command for each talker comprises:
determining, by the vehicle terminal, a validity for the command for each talker based on the analysis result; and
selecting, by the vehicle terminal, a valid command.

20. The method of claim 19, wherein performing the operation corresponding to the command for each talker comprises:
classifying, by the vehicle terminal, the selected valid command into a domain; and
determining, by the vehicle terminal, an execution order depending on a priority in the classified domain.

21. The method of claim 20, wherein performing the operation corresponding to the command for each talker comprises:
executing, by the vehicle terminal, the selected valid command depending on the priority in the classified domain.
